(19) United States
(12) Patent Application Publication
(10) Pub. No.: US 2011/0215862 A1
(43) Pub. Date: Sep. 8, 2011

(54) INTERNAL SUPPLY VOLTAGE CIRCUIT OF AN INTEGRATED CIRCUIT

(75) Inventor: Francesco La Rosa, Rousset (FR)

(73) Assignee: STMICROELECTRONICS (ROUSSET) SAS, Rousset (FR)

(21) Appl. No.: 13/038,160

(22) Filed: Mar. 1, 2011

(30) Foreign Application Priority Data
Mar. 2, 2010 (FR) 1000848

(51) Int. Cl. G05F 1/10; G05F 3/16

(52) U.S. Cl. 327/541; 323/313

(57) ABSTRACT

The disclosure relates to a method for generating a setpoint voltage in an integrated circuit, comprising generating a substantially constant reference voltage, and generating from the reference voltage, a setpoint voltage comprising a component equal to the highest threshold voltage of all the CMOS transistors of a circuit of the integrated circuit and a component which may be equal to zero. The disclosure applies in particular to the provision of a power supply voltage of a circuit based on CMOS transistors.

### BACKGROUND

1. Technical Field

The present disclosure relates to an internal power supply circuit of a logic circuit, particularly based on CMOS transistors in an integrated circuit.

2. Description of the Related Art

Many circuits made in integrated circuits utilize supply voltages having values with precisions that increase with the integration density of the integrated circuits. To obtain precision, power supply voltages are regulated from precise setpoint signals, kept constant during the operation of the circuit.

A conventional example of internal power supply circuit of an integrated circuit is schematically shown in FIG. 1. FIG. 1 shows an integrated circuit IC, comprising an internal power supply circuit comprising a setpoint voltage generator RFGN and a voltage converter DCVT, receiving an external power supply voltage EV from the integrated circuit. The generator RFGN supplies a setpoint voltage Vc to the converter DCVT. The converter DCVT supplies an internal power supply voltage IV powering a circuit INTC of the integrated circuit, as a function of the setpoint voltage. The voltage IV is usually lower than the external power supply voltage EV.

The internal power supply voltage IV is generated so as to stay as stable as possible despite the presence of variations of the operating conditions of the integrated circuit, such as the ambient temperature, the external power supply voltage of the integrated circuit, or the presence of process corners of the integrated circuit. Now the stability of the internal power supply voltage IV depends in particular on that of the setpoint voltage Vc. The generator RFGN is therefore also designed so as to supply a setpoint voltage as stable as possible. Thus, the patent application US 2005/0237104 describes a circuit supplying a setpoint voltage which remains as stable as possible despite the presence of performance variations of the integrated circuit, due in particular to variations of the ambient temperature and process corners of the integrated circuit.

However, despite the implementation of such power supply circuits, some process corners may be noticed in the operation of integrated circuits, and in particular in circuits based on CMOS transistors. Thus, FIG. 2 represents curves T1, F1, S1 showing the operation of a simple ring oscillator made using CMOS transistors and powered by the power supply circuit of FIG. 1. The curves T1, F1, S1 show frequency variations of the signal supplied by the oscillator as a function of the ambient temperature, this frequency being representative of the oscillator performances. Each curve T1, F1, S1 corresponds to a statistical model of integrated circuit, coming from the statistical analysis of the impact of process corners on the performances of integrated circuits. The curve T1 corresponds to a model of “typical” integrated circuit, i.e., having typical characteristics. The curves F1 and S1 correspond to models of so-called “fast” and “slow” integrated circuits, located at three standard deviation units on each side of the typical model, knowing that the statistical distribution of a set point of integrated circuits, regarding the operation performances thereof, usually follows a Gaussian curve. The curves T1, F1, S1 show a significant variation, from 14 MHz to 198 MHz, of the frequency of the output signal of the oscillator, when the ambient temperature of the integrated circuit varies from around −40° C. to around +105° C., and when the process corners vary between the “slow” model and the “fast” model.

In addition, if the power supply voltage of a circuit based on transistors is too low, it may be insufficient to reach the threshold voltage of the circuit transistors and allow them to switch. Conversely, the higher the power supply voltage is, the higher the consumption of the circuits it powers is.

### BRIEF SUMMARY

Thus, it may be desired to power a circuit based on CMOS transistors, so as to maintain the operation characteristics thereof as stable as possible, even in the presence of differences in the circuit performances due to variations of the operating conditions (ambient temperature, external power supply voltage, etc.) and manufacture conditions of the integrated circuit. It may also be desired to power a circuit based on CMOS transistors so that the electrical consumption thereof is minimum without risking an incorrect operation of the circuit due to an insufficient power supply voltage.

Embodiments relate to a method for generating a setpoint voltage in an integrated circuit, comprising generating a substantially constant reference voltage, and generating from the reference voltage, a setpoint voltage comprising a component equal to the highest threshold voltage of all the CMOS transistors of a circuit of the integrated circuit and a component which may be equal to zero.

According to one embodiment, the method comprises generating a substantially constant reference current from the reference voltage, supplying the reference current generated to an input of a detection circuit comprising a P-channel CMOS transistor and a N-channel CMOS transistor, connected to an input of the detection circuit, so as to switch to a conductive state as soon as the setpoint voltage gets higher than a threshold voltage of each transistor, and taking the setpoint voltage from an input of the detection circuit.

According to one embodiment, the method comprises generating a substantially constant reference current from the reference voltage, supplying the reference current generated to an input of a source terminal of a P-channel CMOS transistor and a gate terminal of a N-channel CMOS transistor, a drain terminal of the P-channel transistor being connected to a drain terminal of the N-channel transistor, a source terminal of the N-channel transistor and a gate terminal of the P-channel transistor being connected to the ground, and taking the setpoint voltage from the source of the P-channel transistor.

According to one embodiment, the method comprises supplying the setpoint voltage through a switch mounted in parallel with a capacitor, the switch being controlled to cyclically load and unload the capacitor, so as to maintain the reference voltage substantially constant during phases where the switch is open.

Embodiments also relate to a method for generating an internal power supply voltage of a logic circuit in an integrated circuit, comprising: generating a setpoint voltage in accordance with the method for generating a setpoint voltage previously described, and generating an internal power supply voltage regulated as a function of the setpoint voltage, from an external power supply voltage supplied to the integrated circuit.

According to one embodiment, the internal power supply voltage is substantially equal to the setpoint voltage.

According to one embodiment, the method comprises adjusting the reference current generated, to adjust the reference voltage and thus the internal power supply voltage.

According to one embodiment, the reference current is adjusted to compensate a difference of performance of the integrated circuit in relation to rated performances, due to process corners of the integrated circuit.

According to one embodiment, the reference current is adjusted by a resistor having a temperature coefficient chosen to compensate a difference of performance of the integrated circuit in relation to rated performances, due to variations of ambient temperature of the integrated circuit.

Embodiments also relate to a circuit for generating a setpoint voltage in an integrated circuit, configured to implement the method for generating a setpoint voltage previously defined.

According to one embodiment, the circuit comprises a current source generating a substantially constant reference current from the reference voltage, and a detection circuit receiving in input the reference current and comprising a P-channel MOS transistor and a N-channel MOS transistor, connected to an input of the detection circuit, so as to switch to a conductive state as soon as the setpoint voltage gets higher than a threshold voltage of each transistor, the setpoint voltage being taken from an input of the detection circuit.

According to one embodiment, the circuit comprises a current source generating a substantially constant reference current from the reference voltage, and a detection circuit comprising a N-channel MOS transistor and a P-channel MOS transistor, the P-channel MOS transistor comprising a source terminal receiving a reference current, a gate terminal connected to the ground, and a drain terminal connected to a drain terminal of the N-channel MOS transistor, the N-channel MOS transistor comprising a gate terminal receiving the reference current and a source terminal connected to the ground, the setpoint voltage being taken from the source terminal of the P-channel transistor.

According to one embodiment, the circuit comprises a current source for generating a reference current, the current source being adjustable to adjust the intensity of the reference current, so as to adjust the setpoint voltage.

According to one embodiment, the circuit comprises a switch mounted in parallel with a capacitor, the switch supplying the setpoint voltage, and a control circuit to control the switch so as to cyclically load and unload the capacitor, so as to maintain the setpoint voltage substantially constant during phases where the switch is open.

Embodiments also relate to an internal power supply circuit of an integrated circuit, comprising a circuit for generating a setpoint voltage and a circuit for generating an internal power supply voltage of the integrated circuit, from the setpoint voltage. According to one embodiment, the setpoint voltage generation circuit is in accordance with the circuit previously defined.

Embodiments also relate to an integrated circuit comprising an internal power supply circuit as previously described.

### BRIEF DESCRIPTION OF THE SEVERAL VIEWS OF THE DRAWINGS

Example embodiments of the disclosure will be described below in relation with, but not limited to the appended figures wherein:

FIG. 1 previously described schematically shows an internal power supply circuit of an integrated circuit,

FIG. 2 previously described shows variation curves of an operating parameter of a circuit in an integrated circuit as a function of the ambient temperature,

FIG. 3 schematically shows an internal power supply circuit of an integrated circuit, according to one embodiment,

FIGS. 4 and 5 schematically show embodiments of a circuit for generating a setpoint voltage of the internal power supply circuit,

FIGS. 6A, 6B, 6C show variation curves of the drain-source voltage of transistors of a detection circuit of the circuit of FIG. 5, as a function of the drain-source current passing through these transistors,

FIG. 7 shows variation curves of a reference current as a function of a setpoint voltage supplied by the circuit of FIG. 5,

FIG. 8 schematically shows a circuit for generating a reference current of the circuit of the setpoint voltage generation circuit,

FIG. 9 schematically shows a circuit for generating a setpoint voltage, according to another embodiment,

FIG. 10 shows an example of circuit powered by the power supply circuit,

FIG. 11 shows variation curves of the internal power supply voltage supplied by the power supply circuit, as a function of the ambient temperature,

FIG. 12 shows variation curves as a function of the ambient temperature, of an operating parameter of a circuit powered by the power supply circuit,

FIG. 13 shows variation curves of the internal power supply voltage supplied by the integrated circuit, as a function of the ambient temperature,

FIG. 14 shows variation curves as a function of the ambient temperature, of an operating parameter of a circuit powered by the power supply circuit.

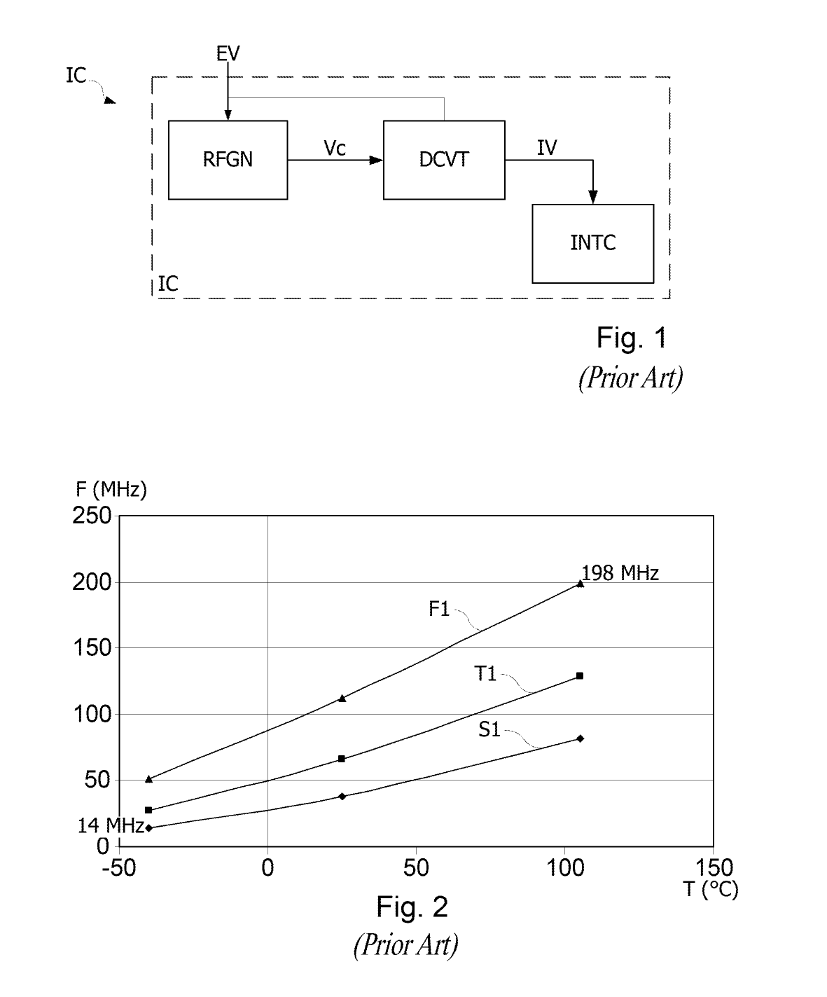

### DETAILED DESCRIPTION

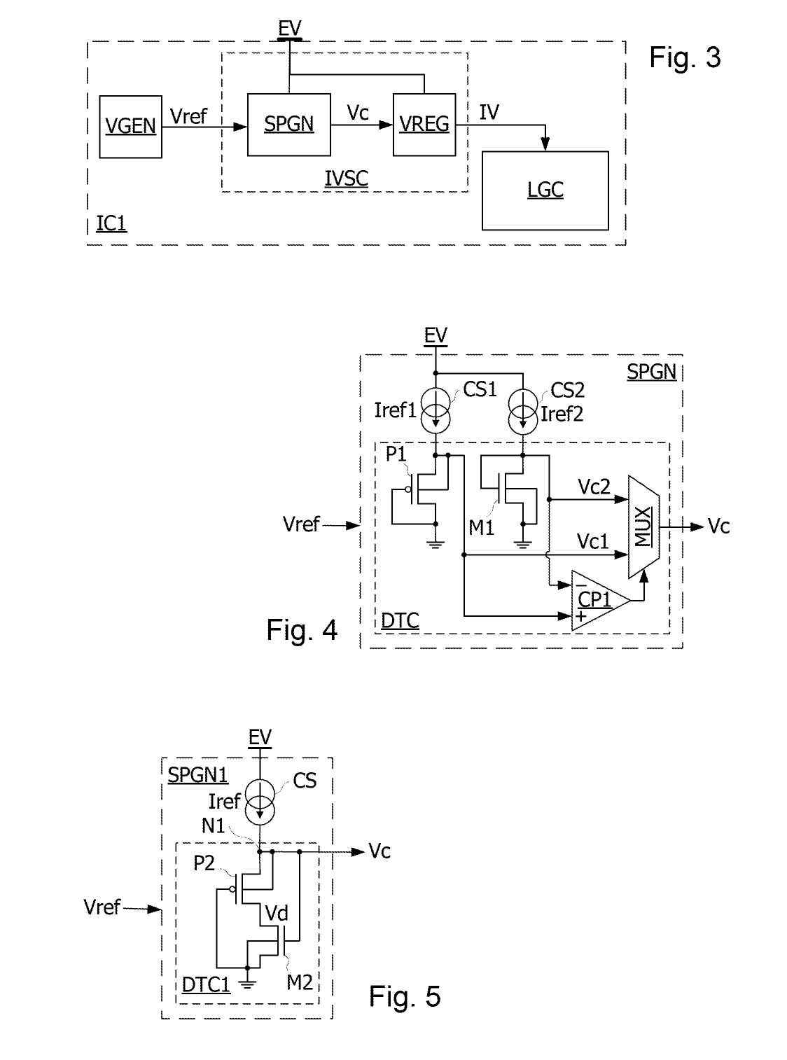

FIG. 3 shows an integrated circuit IC1 comprising an internal power supply circuit IVSC, a reference voltage generation circuit VGEN, and a circuit LGC powered by the circuit IVSC. The circuit IVSC receives a reference voltage Vref supplied by the circuit VGEN. The circuit IVSC comprises a circuit for generating a setpoint voltage SPGN, and a voltage regulation circuit VREG, receiving an external power supply voltage EV supplied to the integrated circuit IC1. The circuit SPGN supplies a setpoint voltage Vc to the circuit VREG and the circuit VREG supplies an internal power supply voltage IV regulated as a function of the setpoint voltage Vc, to power the circuit LGC. The circuit LGC may comprise transistors of CMOS type. The voltage Vref is substantially constant, i.e., in particular independent of the ambient temperature of the integrated circuit and the manufacture conditions thereof.

According to one embodiment, the circuit SPGN is configured so that the setpoint voltage generated varies as a function of threshold voltages Vtn, Vtp of N-channel and P-channel CMOS transistors of the circuit LGC powered:

Vc=F(Vtp,Vtn) (1)

The function F may be chosen so as to compensate at least partially performance variations of the integrated circuit IC1, in relation to average values, the performance variations may be linked in particular to variations of the ambient temperature, and/or of the external power supply voltage EV and/or of the manufacturing conditions of the integrated circuit.

The internal power supply voltage IV supplied by the circuit VREG may be substantially proportional (with a possible difference up to 10%) to the reference voltage Vc, but remains independent of the external power supply voltage EV. Thus, the circuit VREG may be configured so that the voltage IV is equal to the voltage Vc or higher than it, according to the switching rate and the electrical consumption desired for the circuit LGC. In an embodiment, the internal power supply voltage IV is substantially equal (with a possible difference up to 10%) to the reference voltage Vc. The circuit SPGN may then be configured so that the voltage Vc generated is minimum, but higher than the threshold voltages Vtp, Vtn.

FIG. 4 shows an embodiment of the setpoint voltage generation circuit SPGN. The circuit SPGN comprises two current sources CS1, CS2, and a detection circuit DTC. The circuit DTC comprises a P-channel CMOS transistor P1, an N-channel CMOS transistor M1, a multiplexer MUX and a comparator CP1. The current sources CS1, CS2 receive the external power supply voltage EV and each supply a reference current Iref1, Iref2. The current source CS1 is connected to the source and the substrate of the transistor P1 which gate and drain are connected to the ground. The current source CS2 is connected to the drain and the gate of the transistor M1 which source and substrate are connected to the ground. Thus, the transistors P1 and M1 are each mounted in a diode-configuration between the current source CS1, CS2 and the ground. The source of the transistor P1 connected to the current source CS1 supplies a setpoint voltage Vc1 which is applied to an input of the multiplexer MUX and the comparator CP1. The drain of the transistor M1 connected to the current source CS2 supplies a setpoint voltage Vc2 which is applied to another input of the multiplexer MUX and the comparator CP1. The multiplexer MUX supplies the setpoint voltage Vc equal to the higher of the two voltages Vc1, Vc2. Now each voltage Vc1, Vc2 comprises a component equal to the corresponding threshold voltage Vtp, Vtn and a component Vo1, Vo2 depending on the currents Iref1, Iref2. That way, the voltage Vc comprises a component equal to the higher threshold voltage Vtp, Vtn of the transistors P1, M1 and a component Vo depending on the current Iref1 or Iref2:

Vc=MAX(Vtp,Vtn)+Vo(Iref1,Iref2) (2)

where Vo(Iref1, Iref2)=MAX(Vo1(Iref1), Vo2(Iref2))

As the reference voltage Vc is generated by a circuit comprising both a P-channel MOS transistor (transistor P1) and a N-channel MOS transistor (transistor M1), the reference voltage Vc is generated taking into account the influence of the ambient temperature and manufacturing conditions, on one and the other of these two types of transistors. As the transistors P1, M1 belong to the integrated circuit IC1, they are manufactured in the same conditions as the transistors of the circuit LGC. Thus, the threshold voltages Vtp, Vtn of the transistors P1, M1 may be identical to those of the transistors of the logic circuit LGC. The result is that if the transistors P1 and M1 have lower threshold voltages Vtp, Vtn than those of the transistors of a “typical” integrated circuit (which performances can be compared to the typical statistical model), the voltage Vc generated will be lower than in a “typical” integrated circuit. The power supply voltage IV generated from the voltage Vc will also be lower than that generated in a “typical” integrated circuit. Conversely, if the transistors P1 and M1 have higher threshold voltages than those of the transistors of a “typical” integrated circuit, the voltage Vc generated will be higher than in a “typical” integrated circuit. The power supply voltage IV generated from the voltage Vc will also be higher than that generated in a “typical” integrated circuit. The effect of performance variations due to process corners is thus at least partially compensated. It is to be noted that the external power supply voltage has no influence on the operation of the circuit SPGN, since it is controlled by a current generator. The setpoint voltage Vc supplied therefore only depends on the reference current generated and the characteristics of the transistors (which vary as a function of the temperature and the manufacturing conditions thereof).

The transistors P1 and M1 are subjected, like the transistors of the logic circuits LGC of the integrated circuit IC1, to the ambient temperature. These parameters affect their threshold voltage Vtp, Vtn. Now the threshold voltage of the transistors of CMOS type decreases when the temperature increases. The result is that the voltage Vc also decreases, which causes a decrease in the power supply voltage IV. The effect of the ambient temperature increase on the logic circuits LGC of the integrated circuit powered by the power supply voltage IV is thus also at least partially compensated.

The voltage Vc and therefore the power supply voltage IV are thus generated so as to compensate, at least partially, performance variations of the integrated circuit, in relation to average values, the performance variations being due in particular to variations of the ambient temperature, or manufacturing conditions of the integrated circuit.

FIG. 5 shows another embodiment of the setpoint voltage generation circuit. In FIG. 5, the circuit SPGN1 for generating the setpoint voltage Vc comprises a current source CS and a detection circuit DTC1 comprising a P-channel CMOS transistor P2 and an N-channel CMOS transistor M2. The circuit DTC1 receives at a node N1 a current Iref generated by the source CS. The source and the substrate of the transistor P2, as well as the gate of the transistor M2 are connected to the node N1. The drain of the transistor P2 is connected to the drain of the transistor M2. The gate of the transistor P2, as well as the substrate and source of the transistor M2 are connected to the ground. The setpoint voltage Vc is taken from the node N1.

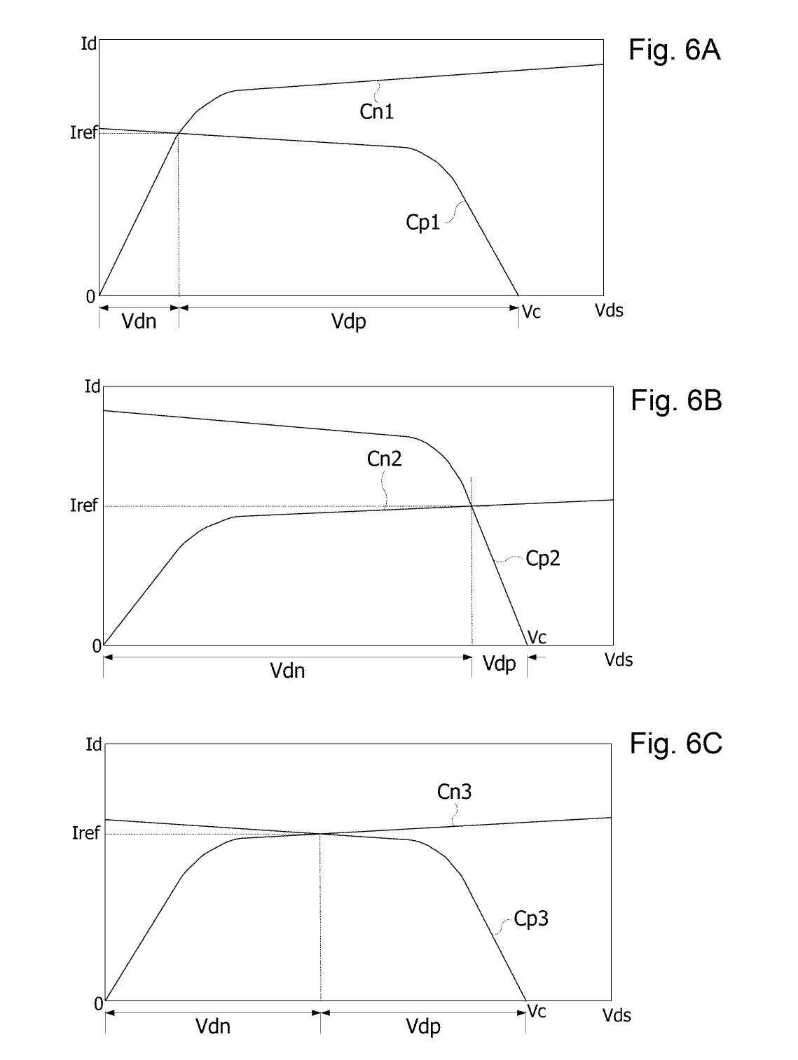

FIGS. 6A, 6B, 6C show variation curves Cn1, Cn2, Cn3 of the drain-source current I passing through the transistor M2 as a function of the drain-source voltage Vds thereof, and variation curves Cp1, Cp2, Cp3 of the source-drain current Id passing through the transistor P2, as a function of the voltage Vc-Vds, where Vds is the drain-source voltage of M2. FIGS. 6A, 6B, 6C show that the circuit SPGN1 of FIG. 5 reaches an operating point located at the intersection of the curves Cn1 and Cp1, Cn2 and Cp2, Cn3 and Cp3, i.e., when the voltage Vds of the transistor M2 reaches a voltage Vdn, the voltage Vds of the transistor P2 reaches a voltage Vdp, for a current I equal to the current Iref supplied by the source CS. The setpoint voltage Vc is then equal to the sum of the voltages Vdn and Vdp. When the operating point is reached, the gate-source voltage Vgs of the transistor M2 is equal to Vc, and the gate-source voltage of the transistor P2 is equal to—Vc.

FIG. 6A shows the case where the transistor M2 has a threshold voltage Vtn higher than that Vtp of the transistor P2. The operating point (Vdn, Iref) is then in the linear operating area of the transistor M2 and the operating area in saturation of the transistor P2.

FIG. 6B shows the case where the transistor M2 has a threshold voltage Vtn lower than that Vtp of the transistor P2. The operating point (Vdn, Iref) is then in the linear operating area of the transistor P2 and the operating area in saturation of the transistor M2.

FIG. 6C shows the case where the transistors M2 and P2 have substantially identical threshold voltages Vtn and Vtp. The operating point (Vdn, Iref) is then in a same operating area, linear or in saturation, of the transistors P2 and M2, according to the value of the current Iref (operating area in saturation in the example of FIG. 6C).

Given the interconnection mode of the transistors P2, M2, the setpoint voltage Vc reaches a constant value different from zero as soon as both transistors are simultaneously conductive. Now the transistors P2 and M2 are interconnected so that the voltage between the gate and the source of each transistor P2 and M2 is fixed at the voltage Vc which is in addition equal to the sum of the voltages Vdn, Vdp between the source and the drain of the transistors P2 and M2. Each transistor P2, M2 is conductive as soon as the voltage between the gate and the source thereof is higher than the threshold voltage Vtp, Vtn thereof. This condition is therefore achieved when the voltage Vc reaches the higher threshold voltage Vtp, Vtn of both transistors P2, M2. The transistors P2 and M2 are thus interconnected so as to behave like a single diode having a threshold voltage equal to the higher threshold voltage of the threshold voltages Vtp, Vtn of the transistors P2, M2. The setpoint voltage Vc therefore comprises a component equal to the higher of both threshold voltages Vtp, Vtn and a component Vo depending on the current Iref:

Vc=MAX(Vtp,Vtn)+Vo(Iref) (2)

Indeed, when the current Iref is increased, the curves Cn1 and Cp1 (or Cn2, Cp2 or Cn3, Cp3) move towards higher current I values, so that the current Iref still corresponds to the intersection point of the curves Cn1 and Cp1 (or Cn2, Cp2 or Cn3, Cp3).

If the power supply voltage IV generated by the regulation circuit VREG is substantially equal to the voltage Vc, and if the setpoint voltage Vc is minimum (equal to MAX(Vtp, Vtn)+Vo, the voltage V0 being very low—for example equal to 10% of the voltage Vc maximum), the voltage IV generated is minimum while being sufficient to guarantee a correct operation of a circuit based on CMOS transistors powered by the voltage IV.

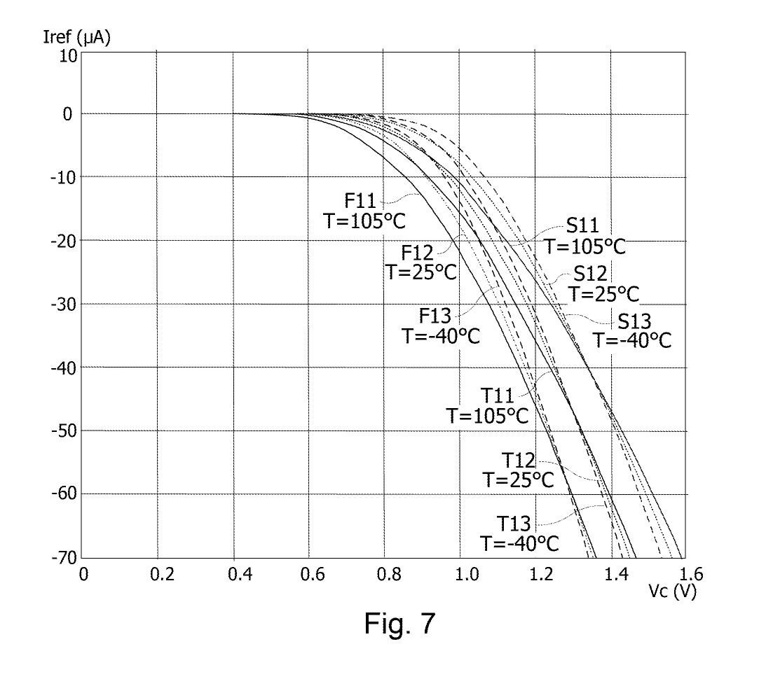

FIG. 7 shows variation curves of a current-voltage characteristic of the circuit SPGN1, measured at −40, +25 and +105° C. in integrated circuits complying with the “typical”, “fast” and “slow” models. The curves F11, F12, F13 were obtained with an integrated circuit complying with the “fast” model brought to an ambient temperature, respectively of +105° C., +25° C. and −40° C. The curves T11, T12, T13 were obtained with an integrated circuit complying with the “typical” model brought to an ambient temperature, respectively of +105° C., +25° C. and −40° C. The curves S11, S12, S13 were obtained with an integrated circuit complying with the “slow” model brought to an ambient temperature, respectively of +105° C., +25° C. and −40° C.

As long as the voltage Vc at the node N1 has not reached a value higher than the threshold voltages Vtp, Vtn (between 0.5 and 0.7 V in FIG. 6), both transistors P2, M2 are not conductive. The voltage Vc at the node N1 then increases until the current passing through the transistors P2 and M2 reaches the reference current Iref. When the current Iref is fixed at a value comprised between 1 and 15 μA, the voltage Vc generated varies around 0.05 V for each “typical”, “fast” and “slow” model of integrated circuit, when the ambient temperature varies between −40 and +105° C. The voltage Vc generated also varies around 0.1 V between the “typical” model to the “fast” or “slow” model at ambient temperature, when the current Iref is fixed at a value comprised between 1 and 15 μA. It may also be noticed that the voltage Vc substantially increases linearly as a function of the current Iref when the voltage Vc is higher than the threshold voltages Vtp, Vtn.

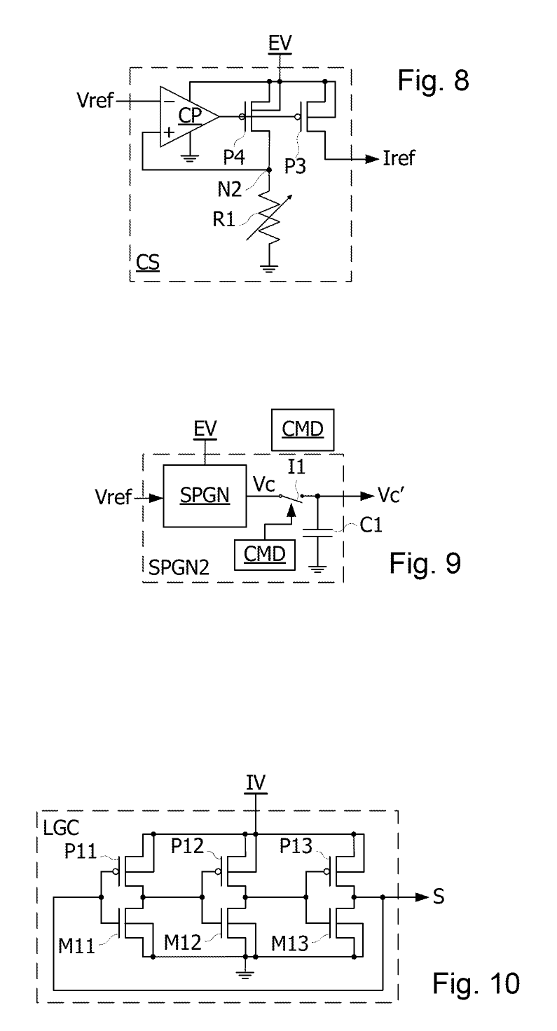

FIG. 8 shows an embodiment of the current source CS (or CS1, CS2). The current source CS comprises two P-channel MOS transistors P3, P4, a comparator CP and a resistor R1. The source and the substrate of the transistors P3, P4 receive the power supply voltage EV. The drain of the transistor P3 is connected to the node N1. The drain of the transistor P4 is connected to a node N2 at the resistor R1 which is connected to the ground. The node N2 is connected to a direct input of the comparator CP. An output of the comparator CP is connected to the gate of each transistor P3, P4. An inverting input of the comparator CP receives the reference voltage Vref supplied by the voltage generator VGEN. The comparator CP is powered by the power supply voltage EV.

The comparator CP allows the node N2 to be maintained at the voltage Vref. A current equal to Vref/R therefore passes through the node N2, where R is the value of the resistor R1. The two transistors P3, P4 operate in current mirror. The currents at the nodes N1 and N2 are therefore identical. The result is that the current Iref at the node N1 is also equal to Vref/R. The generator VGEN may be a bandgap reference circuit. Such a circuit is present in most of the integrated circuits to supply a substantially constant reference voltage. An example embodiment of such a circuit is described in the U.S. Pat. No. 7,633,334.

The resistor R1 may be adjustable so as to be able to adjust the value of the current Iref. The current Iref may thus be increased by decreasing the value of the resistor R1, which allows the voltage Vc and therefore the internal power supply voltage IV to be increased. Conversely, the voltage IV may be decreased by increasing the value of the resistor R1, which decreases the current Iref and therefore the voltage Vc. The rate at which the circuit LGC powered by the power supply circuit IVSC operates increases to the detriment of the circuit electrical consumption. If it is wished to limit the electrical consumption of the circuit LGC, the current Iref may be decreased by increasing the value R of the resistor R1.

To be adjustable, the resistor R1 may conventionally comprise several resistors in series with a switch mounted in parallel on each resistor, each switch being controlled by a cell of a register comprising several cells.

FIG. 9 shows a reference voltage generator SPGN2, according to another embodiment. The generator SPGN2 differs from the generator SPGN or SPGN1 in that it comprises a switch I1 between the node N1 and the output of the setpoint voltage Vc of the generator SPGN2, and a capacitor C1 connected between this output and the ground. A control circuit CMD controls the switch I1 so that it periodically switches so as to load the capacitor C1 during the periods when the switch is closed, and let the capacitor C1 unload during the periods when the switch is open. The duration of the periods when the switch I1 is open and closed, and the capacitance of the capacitor C1 are adapted to allow the capacitor C1 to maintain the voltage Vc substantially constant (with a possible difference up to 10%) when the switch I1 is open. The circuit SPGN (or SPGN1) may also be disconnected right after the opening of the switch I1, and powered right before the closing thereof. These arrangements allow the statistical electrical consumption of the integrated circuit IC1 to be reduced, in particular if the circuit VREG extracts little current through its input receiving the setpoint voltage Vc.

FIG. 10 shows an example of logic circuit LGC powered by the internal power supply voltage IV. The logic circuit LGC comprises a ring oscillator with three inverters in series comprising an output looped to an input of a first of the inverters. Each inverter is conventionally made using a P-channel CMOS transistor P11, P12, P13 and an N-channel CMOS transistor M11, M12, M13. The source and the substrate of each transistor P11, P12, P13 receive the power supply voltage IV. The source and the substrate of each transistor M11, M12, M13 are connected to the ground. The drains of the transistors M11, P11 of a first inverter are each connected to the gates of the transistors M12, P12 of a second inverter. The drains of the transistors M12, P12 of the second inverter are each connected to the gates of the transistors M13, P13 of a third inverter. The drains of the transistors M13, P13 of the third inverter are each connected to an output S of the oscillator and to the gates of the transistors M11, P11 of the first inverter.

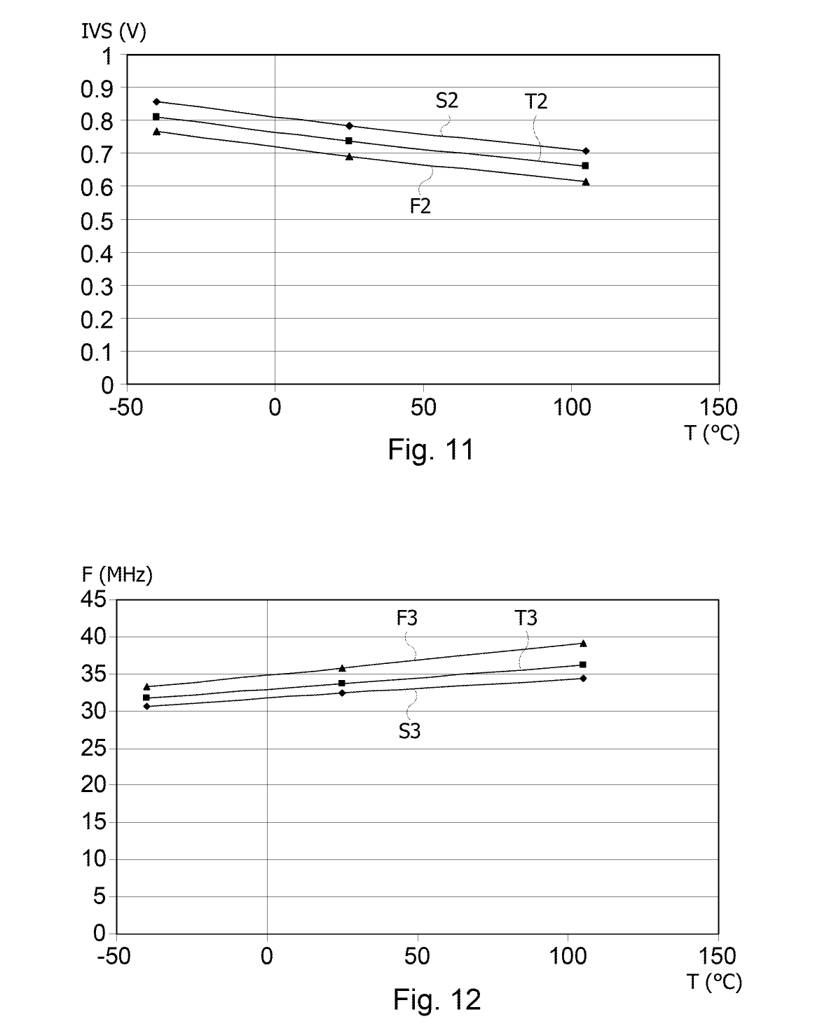

FIGS. 11 to 14 represent curves showing the operation of an integrated circuit an internal circuit of which is powered by the power supply circuit IVSC comprising the reference voltage generator RFGN1, RFGN2 or RFGN3. FIG. 11 shows variation curves T2, F2, S2 of the power supply voltage IV as a function of the ambient temperature, when the reference current Iref is fixed at around 1 μA. Each curve T2, F2, S2 corresponds to a statistical model of integrated circuit, resulting from the statistical analysis of the impact of process corners on the performances of integrated circuits. The curves T2, F2 and S2 respectively correspond to the “typical”, “fast” and “slow” models of integrated circuits. The curves T2, F2, S2 show that the power supply voltage IV varies between around 0.87 V and 0.62 V, when the ambient temperature of the integrated circuit varies between around −40° C. and +105° C., and when the process corners vary between the “slow” model and the “fast” model. It may also be observed that the curve S2 corresponding to the “slow” model is located above the curve F2 corresponding to the “fast” model and that the voltage IV decreases when the ambient temperature increases. It may be deduced therefrom that the internal power supply circuit previously described, and in particular the circuit RFGN1 or RFGN2, automatically performs a compensation of both the temperature and the process corners.

FIG. 12 shows variation curves T3, F3, S3 as a function of the ambient temperature, of the frequency of the output signal of a circuit such as the oscillator of FIG. 10, receiving the power supply voltage IV, when the reference current Iref is fixed at around 1 μA. The oscillator output frequency is representative of the transistor switching rates depending on the threshold voltages Vtn, Vtp of the CMOS transistors of the oscillator, and therefore the performances of the integrated circuit IC1. The curves T3, F3 and S3 respectively correspond to the “typical”, “fast” and “slow” models of integrated circuits. The curves T3, F3, S3 show that the frequency of the output signal of the oscillator increases from around 32 MHz to reach around 38 MHz, when the ambient temperature of the integrated circuit varies from around −40° C. to around +105° C., and when the process corners vary between the “slow” model and the “fast” model. This frequency variation amplitude (around 6 MHz, i.e., around 18% in relation to an average value of 33 MHz) clearly appears reduced in comparison to that (around 184 MHz, i.e., around 263% in relation to an average value of 70 MHz) which may be observed on the curves T1, F1, S1 of FIG. 2. This decrease of the variation amplitude observed reveals the effect of automatic compensation made by the circuit RFGN1 or RFGN2 to obtain operating performances of the integrated circuit varying in substantially reduced proportions.

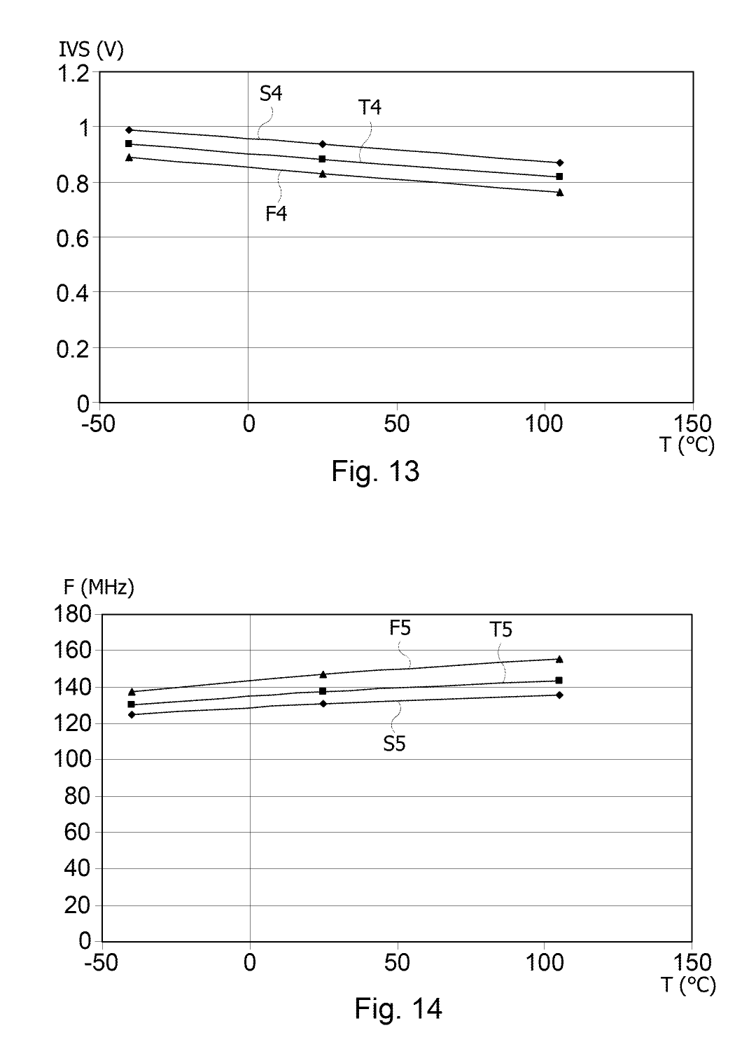

FIG. 13 shows variation curves T4, F4, S4 of the power supply voltage IV as a function of the ambient temperature, when the reference current Iref is fixed at around 5 μA. The curves T4, F4 and S4 respectively correspond to the “typical”, “fast” and “slow” models of integrated circuits. The curves T4, F4, S4 show that the power supply voltage IV decreases from around 0.99 V to reach around 0.78 V, when the ambient temperature of the integrated circuit varies from around −40° C. to around +105° C., and when the process corners vary between the “slow” model and the “fast” model. Here again, it may also be observed that the curve S4 corresponding to the “slow” model is located above the curve F4 corresponding to the “fast” model, and in the curves T4, F4 and S4, the voltage IV decreases when the ambient temperature increases. An automatic compensation of the process corners and in temperature may therefore also be observed when the current Iref is fixed to another value.

FIG. 14 shows variation curves T5, F5, S5 of the frequency of the output signal of a circuit such as the oscillator of FIG. 10, receiving the power supply voltage IV, as a function of the ambient temperature, when the reference current Iref is fixed at around 5 μA. The curve T5 corresponds to the “typical” integrated circuit model. The curves F5 and S5 correspond to the “fast” and “slow” integrated circuit models. The curves T5, F5, S5 show that the frequency of the output signal of the oscillator increases from around 124 MHz to reach around 156 MHz, when the ambient temperature of the integrated circuit varies from around −40° C. to around +105° C., and when the process corners vary between the “slow” model and the “fast” model. This frequency variation also appears clearly reduced (around 32 MHz, i.e., around 24% in relation to an average value of 135 MHz) in comparison to that (around 263%) observed on the curves T1, F1, S1 of FIG. 2.

It is to be noted that contrary to the prior art, the aim of the power supply circuit IVSC according to the embodiments described with reference to FIGS. 3 to 5, 8 and 9, is not to supply a constant reference voltage, but a reference voltage which varies so as to compensate at least partially performance variations of the integrated circuit in relation to average values, so as to obtain performances varying in substantially reduced proportions, of around some dozens of percents in relation to an average value, instead of one to several times the average value, when the ambient temperature and the power supply voltage vary in normal operating ranges of the integrated circuit, and when the integrated circuit may vary between the “fast” model and the “slow” model.

It is to be noted that using an adjustable resistor to adjust the value of the current Iref may allow a performance difference of the integrated circuit to be compensated in relation to typical performances. Thus, by adjusting the value of the resistor R1, for example after a manufacturing test phase, it is possible to bring the curves F3, S3, F5 and S5 to the level of the typical curves T3 and T5. That way, the output signal frequency variations observed in FIGS. 12 and 14 may be respectively brought to 12% and 16%.

In addition, the resistor R1 may also have a positive temperature coefficient so that the current Iref increases when the ambient temperature decreases. That way, the circuit rate variation may be more compensated when the ambient temperature varies. Thus, by choosing a resistor R1 having a positive temperature coefficient of adapted value, it is possible to rectify the curves F3, S3, T3, F5, S5, T5 so that the oscillator output frequency is substantially independent of the ambient temperature.

It will be clear to those skilled in the art that the present disclosure is susceptible of various embodiments and applications. In particular, the disclosure is not limited to the power supply circuits previously described. Other circuits than the circuits SPGN, SPGN1 described, may be used to generate a setpoint voltage which is at the minimum equal to the higher threshold voltage Vtp, Vtn of CMOS transistors of an integrated circuit, these threshold voltages being linked in particular to the ambient temperature and the manufacturing conditions of the integrated circuit.

In addition, the present disclosure is not limited to the generation of an internal power supply voltage in an integrated circuit, but may apply to any circuit utilizing a voltage which value which may be adapted to compensate performance differences of the integrated circuit.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
generating a substantially constant reference voltage; and
generating from the reference voltage, a setpoint voltage in an integrated circuit, including a first component equal to a highest threshold voltage of all CMOS transistors of a circuit of the integrated circuit and a second component based on the reference voltage.

2. The method according to claim 1, further comprising:
generating a substantially constant reference current from the reference voltage;
supplying the generated reference current to an input of a detection circuit, the detection circuit including a P-channel CMOS transistor and a N-channel CMOS transistor coupled to the input of the detection circuit;
switching the P-channel CMOS transistor and the N-channel CMOS transistor to a conductive state in response to the setpoint voltage exceeding threshold voltages of the P-channel and N-channel CMOS transistors; and
outputting the setpoint voltage from the input of the detection circuit.

3. The method according to claim 1, further comprising:
generating a substantially constant reference current from the reference voltage;
supplying the generated reference current to a source terminal of a P-channel CMOS transistor and to a gate terminal of a N-channel CMOS transistor, wherein a drain terminal of the P-channel transistor being connected to a drain terminal of the N-channel transistor, wherein a source terminal of the N-channel transistor and a gate terminal of the P-channel transistor being connected to the ground; and
outputting the setpoint voltage from the source of the P-channel transistor.

4. The method according to claim 1, further comprising:
supplying the setpoint voltage through a switch coupled in parallel with a capacitor, the switch being controlled to cyclically load and unload the capacitor so as to maintain the constant reference voltage during phases where the switch is open.

5. A method according to claim 1, further comprising:
generating an internal power supply voltage of a logic circuit in the integrated circuit, wherein generating the internal power supply voltage includes generating the internal power supply voltage as a function of the setpoint voltage from an external power supply voltage supplied to the integrated circuit.

6. The method according to claim 5, wherein the internal power supply voltage is substantially equal to the setpoint voltage.

7. The method according to claim 5, further comprising:
generating a reference current; and
adjusting the reference voltage and the internal power supply voltage by adjusting the reference current.

8. The method according to claim 7, further comprising:
compensating for differences in performance of the integrated circuit due to process corners of the integrated circuit by adjusting the reference current.

9. The method according to claim 7, wherein adjusting the reference current includes using a resistor having a temperature coefficient configured to compensate for a difference in performance of the integrated circuit due to variations of ambient temperature of the integrated circuit.

10. A setpoint generation circuit, comprising:
an input configured to receive a reference voltage;
a current source coupled to the input and configured to generate a substantially constant reference current; and
a detection circuit coupled to the current source and configured to receive the reference current, the detection circuit having a first transistor and a second transistor, the detection circuit being configured to generate a setpoint voltage based upon a first threshold voltage of the first transistor and upon a second threshold voltage of the second transistor.

11. The circuit according to claim 10, wherein the first transistor of the detection circuit is a P-channel MOS transistor and the second transistor is a N-channel MOS transistor, the first and second transistors being coupled to an input of the detection circuit and configured to switch to a conductive state in response to the setpoint voltage getting higher than the first and second threshold voltages, the setpoint voltage being provided from the input of the detection circuit.

12. The circuit according to claim 10, wherein the first transistor of the detection circuit is a N-channel MOS transistor and the second transistor is a P-channel MOS transistor, the P-channel MOS transistor including a source terminal configured to receive the reference current, a gate terminal coupled to a ground, and a drain terminal connected to a drain terminal of the N-channel MOS transistor, the N-channel MOS transistor including a gate terminal configured to receive the reference current and a source terminal connected to the ground, the P-channel transistor being configured to provide the setpoint voltage at the source terminal of the P-channel transistor.

13. The circuit according to claim 10, wherein the at least one current source is adjustable and is configured to adjust the setpoint voltage based on an adjustment of the reference current.

14. A circuit according to claim 10, further comprising:
a capacitor;
a switch coupled with the capacitor, the switch being coupled to the detection circuit and configured to selectively provide the setpoint voltage; and
a control circuit configured to control the switch, the control circuit being operable to cyclically load and unload the capacitor, and maintain the setpoint voltage substantially constant during phases where the switch is open.

15. An internal power supply circuit of an integrated circuit, comprising:
a setpoint generation circuit, having:
an input configured to receive a reference voltage,
a current source coupled to the input and configured to generate a substantially constant reference current, and
a detection circuit coupled to the current source and configured to receive the reference current, the detection circuit having a first transistor and a second transistor, the detection circuit being configured to generate a setpoint voltage based upon a first threshold voltage of the first transistor and upon a second threshold voltage of the second transistor; and
a supply voltage generation circuit coupled to the setpoint generation circuit and configured to receive the setpoint voltage from the setpoint generation circuit, the supply voltage generation circuit configured to generate an internal power supply voltage of the integrated circuit from the setpoint voltage.

16. The internal power supply circuit of claim 15 wherein the current source includes:
a variable resistor;
a comparator coupled to the variable resistor and coupled to the reference voltage; and
at least two P-channel transistors coupled in parallel, the at least two transistors coupled to an external voltage, the at least two P-channel transistors coupled to the comparator, a first of the at least two P-channel transistors configured to generate a feedback voltage by supplying a first current into the variable resistor, the comparator configured to compare the feedback voltage to the reference voltage, a second of the at least two P-channel transistors being configured to supply a second current of similar magnitude as the first current; wherein the detection circuit is configured to generate the setpoint voltage to be at least equal to the sum of the first threshold voltage and the second threshold voltage.

17. The internal power supply circuit of claim 16 wherein the supply voltage generation circuit is switchably coupled to the setpoint generation circuit and the coupling between the setpoint generation circuit and the supply voltage generation circuit is capacitively decoupled from a ground reference.

18. An integrated circuit, comprising:
a setpoint generation circuit, having:
an input configured to receive a reference voltage,
a current source coupled to the input and configured to generate a substantially constant reference current, and
a detection circuit coupled to the current source and configured to receive the reference current, the detection circuit having a first transistor and a second transistor, the detection circuit being configured to generate a setpoint voltage based upon a first threshold voltage of the first transistor and upon a second threshold voltage of the second transistor; and
a supply voltage generation circuit coupled to the setpoint generation circuit and configured to receive the setpoint voltage from the setpoint generation circuit, the supply voltage generation circuit configured to generate an internal power supply voltage of the integrated circuit from the setpoint voltage; and
a logic circuit coupled to the supply voltage generation circuit and configured to receive the internal power supply voltage.

19. The integrated circuit of claim 18 wherein the internal power supply voltage includes a compensation of process variation based on the first threshold voltage and the second threshold voltage of the detection circuit.

20. The integrated circuit of claim 19 wherein the logic circuit is a ring oscillator.
